(19) United States
(12) Patent Application Publication
(10) Pub. No.: US 2025/0208402 A1
(43) Pub. Date: Jun. 26, 2025

(54) HOLDING DEVICE, ARRANGEMENT AND METHOD FOR HOLDING AN ENDOSCOPE OR PART OF AN ENDOSCOPE

(71) Applicant: Olympus Winter & Ibe GmbH, Hamburg (DE)

(72) Inventor: Sascha Eschborn, Ahrensburg (DE)

(73) Assignee: Olympus Winter & Ibe GmbH, Hamburg (DE)

(21) Appl. No.: 18/978,626

(22) Filed: Dec. 12, 2024

(30) Foreign Application Priority Data
Dec. 22, 2023 (DE) 10 2023 136 548.7

(51) Int. Cl. G02B 23/24; B08B 9/032

(52) U.S. Cl. CPC G02B 23/2476; B08B 9/032

(57) ABSTRACT

A holding device for holding at least a part of an endoscope. The holding device including: a frame for placing the holding device, at least one receiving element connected to the frame, the at least one receiving element being configured to at least partly enclose a receiving area for receiving at least the part of the endoscope, and a plurality of holding elements connected to the at least one receiving element. The plurality of holding elements are each configured to rest against and to hold at least the part of the endoscope in a fixed and predefined position.

### CROSS-REFERENCE TO RELATED APPLICATION

The present application is based upon and claims the benefit of priority from DE 10 2023 136 548.7 filed on Dec. 22, 2023, the entire contents of which is incorporated herein by reference.

### BACKGROUND

### Field

The present disclosure relates to a holding device and an arrangement for holding an endoscope and/or a part of an endoscope. Further, the present disclosure relates to a method for holding an endoscope and/or a part of an endoscope and to a use of a holding device.

### Prior Art

After use of an endoscope, the endoscope is typically reprocessed by pre-cleaning, manual or automated cleaning, disinfection, and possibly sterilization, before it can be used again on the patient. However, the cleaning process of complex endoscopes is complicated, which is why the channels and openings of the endoscopes are typically cleaned manually before the endoscope is disinfected. Such a manual cleaning involves manual handling of the contaminated and used endoscopes and furthermore expose the person involved with the cleaning with a potential risk of exposure to contaminants. In addition, manual cleaning and handling of endoscopes involves a risk that the cleaning is not performed correctly so that the desired result after cleaning and disinfection might not be achieved.

In order to minimize or avoid these risks, automated cleaning of endoscopes has been suggested. From WO2019054910A1 it is known an arrangement for cleaning and disinfection of endoscopes comprising a tray and a fixture arranged to maintain the endoscope in the desired position within the tray, wherein a robotic device that comprises a movable robot arm can be operated by a control unit for cleaning at least one channel of the endoscope arranged in the tray.

However, a problem of such an automated cleaning is that during the reprocessing process, adapters must be connected to the opening connections of the endoscopes, and although it is known to equip such arrangements with a camera so that the position of the endoscope can be recognized, the endoscope typically moves slightly around its resting position so that the adapters for an inner endoscope channel flushing cannot be placed precisely on the channel opening connections of the endoscope.

### SUMMARY

Therefore, an object is to provide an improved solution for an automated or partly automated cleaning and disinfection of endoscopes as well as an improved method for conducting the cleaning and disinfection to reduce the described problems.

According to a first aspect, it is provided a holding device for holding an endoscope and/or a part of an endoscope, the holding device comprising: a frame for placing the holding device, at least one receiving element that is connected to the frame and that is configured and arranged to at least partly enclose a receiving area for receiving a part of an endoscope, and a plurality of holding elements that are connected to the at least one receiving element, wherein the holding elements are configured and arranged to rest against and to hold the part of the endoscope in a fixed and predefined position.

The holding device can be configured to hold an endoscope and/or a part of an endoscope in the fixed and predefined position.

The frame can be used to place the holding device on a surface, for example on a tray. The frame can comprise a base plate and a frame structure, wherein the frame structure can be arranged on the base plate and connected to the base plate. The frame can for example be placed in a tray, such as with the base plate resting on the tray. Such a tray can then be moved into a device for conducting an automated cleaning procedure of the endoscope, i.e. into an endoscope cleaning device. However, it is also possible that no base plate is provided but that the frame is built as a single frame structure only.

The at least one receiving element can be fixed to the frame and can be formed in such a way that the at least one receiving element defines the receiving area, wherein the receiving area is at least partly enclosed by the at least one receiving element. The receiving area can be formed to receive an endoscope and/or a part of an endoscope. If an endoscope is placed in the receiving area, it can be at least partly enclosed by the at least one receiving element. The at least one receiving element can have an opening through which the endoscope can be moved into the receiving area and be removed from the receiving area. Such an opening can be arranged on one side, such as sideways, of the at least one receiving element. The at least one receiving element can comprise at least two receiving elements that can be arranged next to each other, wherein these receiving elements can have openings on the same side so that an endoscope can be moved into and out from the receiving area.

The holding elements can be connected to the at least one receiving element in such a way that at least a part of each of the holding elements can be movable relative to the at least one receiving element. The holding elements can be arranged in such a way that they can be arranged along a circular section of the receiving area. The holding elements can be oriented in such a way that their longitudinal axis substantially points into the direction of the receiving area, such as into the direction of the center of the receiving area. The holding elements can be configured to rest against and to hold the part of the endoscope. The holding elements can be configured to apply a force into the direction of a part of the endoscope if such a part of the endoscope is arranged in the receiving area.

An advantage of such a holding device can be that it can be ensured that the endoscope is held in a fixed and predetermined position. This way, a robot can easily attach rinsing adapters to the corresponding channel openings of the endoscope and carry out internal channel flushing of the endoscope.

Another advantage of such a holding device is that it can be achieved that the endoscope or part of the endoscope that is held, is fixed firmly in such a way that it does not change its position if not desired.

Another advantage of such a holding device is that due to the fact that the endoscope or part of the endoscope is held by a plurality of holding elements, the total contact surface between the holding device and the endoscope or part of the endoscope can be relatively small. Thus, it is possible to clean, such as by using spray nozzles, the entire surface or almost the entire surface of the endoscope or part of the endoscope when the endoscope is held by the holding elements in the receiving area.

The holding elements can be movably supported on the at least one receiving element.

At least a part of the holding elements can be movable relative to the at least one receiving element and/or movably supported relative to the at least one receiving element.

The holding elements can each comprise an external thread and the at least one receiving element can comprise a plurality of bores with internal threads, wherein the holding elements can be screwable into the bores of the at least one receiving element, wherein the external threads of the holding elements engage with the internal threads of the bores of the at least one receiving element.

The holding device can comprise at least six, such as at least eight, or at least ten, holding elements.

The longitudinal axes of the holding elements can be oriented in different angles relative to each other. Several of the holding elements can be arranged below the receiving area and/or below the endoscope or the part of the endoscope if an endoscope or a part of an endoscope is arranged in the receiving area. Several of the holding elements can be arranged above the receiving area and/or above the endoscope or the part of the endoscope if an endoscope or a part of an endoscope is arranged in the receiving area. Several of the holding elements can be arranged sideways relative to the receiving area and/or sideways relative to the endoscope or the part of the endoscope if an endoscope or a part of an endoscope is arranged in the receiving area.

An advantage of using at least six, such as at least eight, or at least ten, holding elements is that with such minimum number of holding elements it is possible to fix the endoscope or the part of the endoscope tightly in the predetermined position, so that the endoscope or part of the endoscope does not move, which allows for a robot arm to connect adapters to the endoscope or to the part of the endoscope in a reliable manner.

Another advantage of using such a plurality of holding elements is that the contact surfaces can be relatively small so that the surface can be cleaned particularly well, because no large contact surfaces are present.

The holding elements can comprise polymer and/or can be substantially made of polymer. The holding elements can each comprise a movable contact part that can comprises polymer and/or can be substantially made of polymer. The parts of the holding elements that are configured to be in contact with the endoscope or the part of the endoscope comprise polymer and/or can be substantially made of polymer. An advantage of using polymer for these parts is that the endoscope or part of the endoscope is not damaged by being in contact with these polymer parts.

At least three, such as at least four, or at least six, of the holding elements can be arranged substantially along a circumference of the receiving area to hold the part of the endoscope. At least three, such as at least four, or at least six, of the holding elements can be arranged substantially along a circle, such as a vertically arranged circle.

The circle can extend along a vertical plane. With such a circumferential arrangement, it can be achieved that the endoscope or part of the endoscope is held around its circumference with several holding elements at different position along the circumference.

Each of the holding elements can comprise a body and a contact part, wherein the body and/or the contact part can be moveable along a moving axis and relative to the at least one receiving element, to which the respective holding element is connected to.

For each of the holding elements the contact part can be moved along the moving axis that can correspond to a longitudinal axis of the holding element.

The contact part can be at least partly arranged inside of the body, but can be movable into a position in which the contact part is partly arranged inside of the body and partly arranged outside of the body. The body can be connected to and in contact with the at least one receiving element, such as by a threaded connection.

The moving axis can correspond to a longitudinal extension of the holding element. The moving axis can be oriented parallel to the longitudinal extension of the holding element.

The contact part of the holding element and/or the body of the holding element can be biased by a spring element, such as a compression spring, towards the receiving area, and can be towards the part of the endoscope that is held in the receiving area.

The spring can be arranged at least partly, such as completely, inside of the body of the holding element.

An advantage of using such spring element is that the force with which the contact part presses against an endoscope or a part of an endoscope can be kept at a relatively uniform level. Another advantage of using such a spring element is that when the endoscope or part of endoscope is moved it will return to the predefined position due to the spring forces that act on the endoscope or the part of the endoscope.

The contact part of the holding element can have a contact surface for resting against the part of the endoscope that is held in the receiving area, wherein the contact surface of the contact part can be smaller than the cross section area of the body of the holding element.

For each holding element, the cross section of the contact surface orthogonal to the moving axis of the contact part of the holding element can be smaller than the cross section of the body of the holding element.

An advantage of having such a contact part with a contact surface that has a relatively small cross section is that only a very small amount of the surface of the endoscope or part of the endoscope is covered due to the contact with the contact parts. This allows for preferred cleaning conditions to clean the outer surface of the endoscope or part of the endoscope when the endoscope or part of the endoscope is held in the receiving area by the contact elements.

The at least one receiving element can comprise an upper element that can be movable between an opened position, in which the part of the endoscope is placeable into the receiving area and removable from the receiving area, and a closed position, in which the part of the endoscope is fixed in the predefined position by the holding elements, wherein the upper element can be rotatable about a substantially horizontal axis.

The upper element can be rotatable about an axis, such as a substantially horizontal axis, to move the upper element between the opened position and the closed position.

The at least one receiving element can comprise a lower element that is not movable and to which the upper element can be rotatably connected.

An advantage of such a movable upper element is that in the opened position the endoscope or part of the endoscope can easily be moved into the receiving area and out of the receiving area, and that in the closed position the endoscope or part of the endoscope can be hold in a position in which the endoscope is enclosed by the upper element and the lower element of the at least one receiving element.

The holding device can comprise a lever for moving a control element that can be configured and arranged to move an elevator lever of the endoscope between an opened elevator lever position and a closed elevator lever position, wherein two holding parts, that can be oriented orthogonal to each other, can be arranged on the control element.

The elevator lever of the endoscope can also be referred to as an Albarran lever. The terms elevator lever and Albarran lever are understood as synonyms herein. The elevator lever can be arranged as part of the endoscope or part of the endoscope that is arranged in the receiving area. The elevator lever can be configured to translate a movement of the elevator lever at the control body of the endoscope to the distal tip of the endoscope, so that a tool at the distal tip of the endoscope can be controlled by moving the elevator lever between its open position and its closed position.

The lever can move the elevator lever of the endoscope between the opened elevator lever position, in which the elevator lever can be arranged in an open position, and a closed elevator lever position, in which the elevator lever can be arranged in a closed position.

An advantage of such a lever is that the elevator lever of the endoscope can be moved between its opened elevator lever position and its closed elevator lever position in an automated way, such as by using a robot arm, in such a way that the elevator lever of the endoscope is moved between its opened and its closed position by moving the lever using a robot arm. This way, the elevator lever can be cleaned in an automated and predetermined manner so that, firstly, reliable and precise cleaning of the elevator lever can be achieved and, secondly, reliable and precise cleaning of the distal tip of the endoscope can be achieved, and, thirdly, the cleaning procedure can be carried out with significantly less manual effort.

An important advantage of such a lever is that this way the distal tip of the endoscope can be reliably and completely cleaned, because all parts of the distal tip of the endoscope can only be cleaned completely if the elevator lever is positioned in its open position for a certain cleaning time and in its closed position for another certain cleaning time.

The holding device can comprise a push element, such as a spring element, that can be arranged to apply an opening force between the upper element of the at least one receiving element and the lower element of the at least one receiving element, wherein the opening force can act in such a way that it is directed to move the upper element of the at least one receiving element and the lower element of the at least one receiving element at least partly apart from each other.

The push element can act in such a way that a force can be applied to push the upper element of the at least one receiving element away from the lower element of the at least one receiving element. With such a push element, it can be achieved that the upper element of the at least one receiving element and the lower element of the at least one receiving element are not arranged in the locked position, but rather in the unlocked position, in which the part of the endoscope held in the receiving area is not locked in the predefined and fixed position unless a force acts in a direction opposite of the force of the push element.

An advantage of such a push element is that the part of the endoscope that is arranged in the receiving area can be kept in an unlocked position, in which the endoscope or part of the endoscope can at least slightly be moved, which can be beneficial in order to clean the complete surface of the endoscope or part of the endoscope, including the parts that were in contact with the contact elements.

The holding device can comprise a lock device that can be movable, such as rotatable about a lock device axis, between a locked position, in which the part of the endoscope held in the receiving area is locked in the predefined and fixed position, and an unlocked position, in which the part of the endoscope held in the receiving area is movable about the predefined and fixed position.

The lock device axis can be oriented substantially horizontal. The lock device axis can be oriented in parallel to the axis about which the upper element of the at least one receiving element is rotatable. The lock device can be configured to move between a locked position, in which the upper element of the at least one receiving element and the lower element of the at least one receiving element are arranged in a locked position, and an unlocked position, in which the upper element of the at least one receiving element and the lower element of the at least one receiving element are arranged in an unlocked position. In the locked position, the endoscope or part of the endoscope held in the receiving area can be arranged in the predefined and fixed position, in which the endoscope or the part of the endoscope cannot be moved. In the unlocked position, the endoscope or part of the endoscope arranged in the receiving area can be at least slightly movable about the predefined and fixed position, but cannot be removable from the receiving area. An advantage of providing this unlocked position is that in this position, it is possible to clean the complete surface of the endoscope or part of the endoscope, including the parts that were in contact with the contact elements before, when it had been arranged in the locked position.

An advantage of providing a locked position and an unlocked position is that it is possible to hold the endoscope or the part of the endoscope in a fixed and unmovable position so that an automated cleaning can be conducted and adapters can be connected to the endoscope or part of the endoscope and in addition it is possible to hold the endoscope in the unlocked position, in which the endoscope or part of the endoscope is held in the receiving area but still at least slightly movable so that a complete and reliable surface cleaning can be conducted.

In order to completely clean the outer surfaces, the push element can act to release the endoscope or part of the endoscope from the fixed position so that the endoscope can move slightly around a rest position and spray nozzles can sufficiently clean and disinfect the areas of the outer surface of the endoscope that were in contact with the contact elements.

The holding device can be configured to hold an operating part of the endoscope. The operating part of the endoscope can be understood to be the part of the endoscope that is held by the operator when using the endoscope on a patient.

The holding device can be configured to hold a distal tip of the endoscope. There can be different holding devices provided, wherein at least the following two holding devices are provided: one holding device that can be configured to hold an operating part of the endoscope and one holding device that can be configured to hold the distal tip of the endoscope. These holding devices can be arranged next to each other.

The holding device can be configured to hold a light guide plug of the endoscope.

According to a further aspect, it is provided an arrangement for holding different parts of an endoscope, the arrangement comprising: several holding devices, such as at least three holding devices, for holding different parts of an endoscope, wherein at least one of the holding devices, such as all of the holding devices, can be a holding device as described herein.

The arrangement for holding different parts of an endoscope can comprise at least three holding devices, such as three or four holding devices. One holding device can be configured to hold an operating part of the endoscope and/or one holding device can be configured to hold the distal tip of the endoscope, and/or one holding device can be configured to hold a light guide plug of the endoscope. There can also be provided two holding devices for holding a light guide plug of the endoscope. It is also possible that the arrangement comprises further holding devices.

One of the several holding devices can be configured to hold an operating part of the endoscope and/or one of the several holding devices can be configured to hold a distal tip of the endoscope and/or one of the several holding devices can be configured to hold a light guide plug of the endoscope.

All of the holding devices of the arrangement for holding different parts of an endoscope can be arranged next to each other on a tray. Such a tray can then be moved into a device for conducting an automated cleaning procedure of the endoscope.

According to a further aspect, it is provided a method for holding an endoscope and/or a part of an endoscope, the method comprising: providing a holding device for holding an endoscope and/or a part of an endoscope, such as a holding device as described herein; placing a part of an endoscope in a receiving area that is at least partly enclosed by at least one receiving element of the holding device; and holding the part of the endoscope in a fixed and predefined position by using a plurality of holding elements that are connected to the at least one receiving element, wherein the holding elements rest against the part of the endoscope and are biased by spring elements towards the part of the endoscope.

The method can comprise: connecting, such as by using a robot arm of a robot, at least one flushing adapter to at least one channel opening of the part of the endoscope, wherein liquid can be introduced via the at least one flushing adapter into the at least one channel opening to flush at least one channel of the endoscope.

According to a further aspect, it is provided a use of a holding device for holding an endoscope and/or a part of an endoscope as described herein in an automated endoscope cleaning device, wherein the automated cleaning device comprises a robot having a robot arm that connects at least one flushing adapter to at least one channel opening of the part of the endoscope.

A liquid can be introduced via the at least one flushing adapter into the at least one channel opening to flush at least one channel, such as several channels, of the endoscope.

As to the advantages, embodiments and details of the individual different embodiments, reference is also made to the corresponding advantages, embodiments and details described with reference to the respective other embodiments.

Further embodiments result from the combination of individual, several or all of the features described herein.

### BRIEF DESCRIPTION OF THE DRAWINGS

Embodiments shall now be described with reference to the attached drawings, in which

FIG. 1 illustrates a perspective view of an arrangement for holding different parts of an endoscope, comprising four holding devices;

FIG. 2 illustrates a side view of an arrangement for holding different parts of an endoscope, comprising four holding devices;

FIG. 3 illustrates a perspective view of a holding device;

FIG. 4 illustrates a perspective view of a device for conducting an automated cleaning procedure of an endoscope;

FIG. 5a illustrates a schematic longitudinal cross-sectional view of a first embodiment of a contact element;

FIG. 5b illustrates a schematic longitudinal cross-sectional view of a second embodiment of a contact element; and

FIG. 6 illustrates a flow chart of a method for holding an endoscope and/or a part of an endoscope.

### DETAILED DESCRIPTION

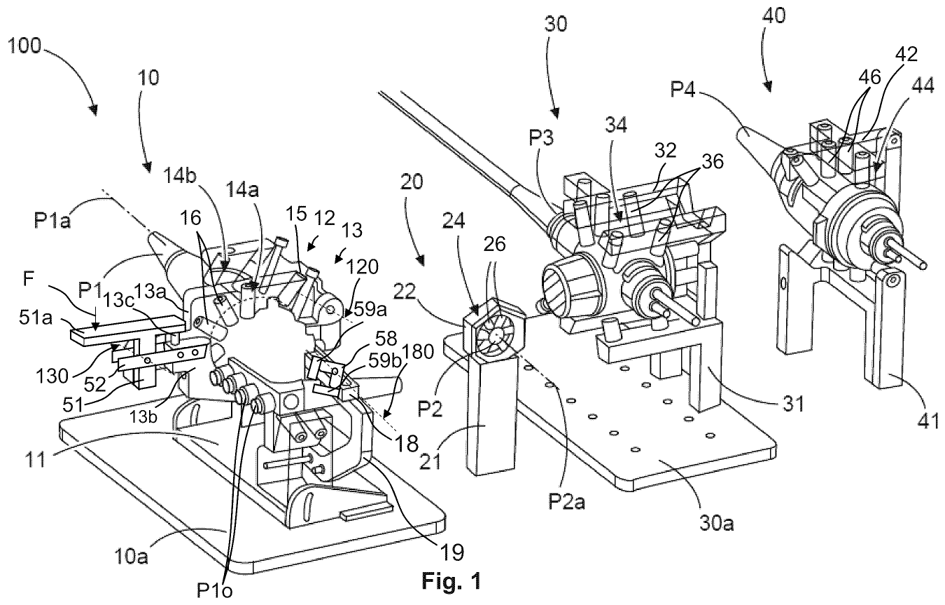

FIG. 1 shows a perspective view of an arrangement 100 for holding different parts of an endoscope, comprising four holding devices 10, 20, 30, 40.

The first holding device 10 is configured to hold an operating part P1 of the endoscope. The operating part P1 has a longitudinal axis P1a that extends through the holding device 10. The operating part P1 comprises channel opening P1o to which adapters can be connected through which a liquid can be introduced into the channels of the endoscope through the channel opening P1o.

The first holding device 10 comprises a frame 11 for placing the holding device 10. The frame 11 is used to place the holding device 10 on a surface, for example on a tray. The frame 11 comprises a base plate 10a and a frame structure that extends from the base plate 10a, wherein the frame structure is arranged on the base plate 10a and connected to the base plate 10a.

The first holding device 10 further comprises two receiving elements 12, 13, wherein each of these receiving elements 12, 13 comprises an upper element that is movable between an opened position, in which the part of the endoscope P1 is placeable into the receiving area and removable from the receiving area 14a, 14b, and a closed position, in which the part of the endoscope P1 is fixed in the predefined position by the holding elements 16. Here, the upper element 13a of the receiving element 13 and the lower element 13b of the receiving element 13 can be seen. The upper element 13a of the receiving element 13 is rotatable about the substantially horizontal axis 120. The receiving elements 12, 13 are connected to the frame 11 and are arranged next to each other so that they form a receiving area 14a, 14b in which the part of the endoscope P1 can be arranged as shown in FIG. 1. The receiving elements 12, 13 are configured and arranged to enclose the receiving area 14a, 14b for receiving the part P1 of the endoscope.

A plurality of holding elements 16 are provided that are connected to the receiving elements 12, 13. The holding elements 16 are configured and arranged to rest against and to hold the part P1 of the endoscope in a fixed and predefined position. The holding elements 16 are screwed into bores 15 that are arranged in the receiving elements 12, 13.

The first holding device 10 comprises a push element 13c that comprises a spring element that is arranged to apply an opening force between the upper element 13a of the receiving element 13 and the lower element 13b of the receiving element 13. The opening force acts in such a way that it is directed to move the upper element 13a of the receiving element 13 and the lower element 13b of the receiving element 13 at least partly apart from each other.

The first holding device 10 further comprises a lock device 51 that is movable, namely rotatable about a lock device axis 130, between a locked position, in which the part of the endoscope P1 held in the receiving area 14a, 14b is locked in the predefined and fixed position, and an unlocked position, in which the part of the endoscope P1 held in the receiving area 14a, 14b is movable about the predefined and fixed position. The lock device 51 has a lock device lever 51a that is rotatable about the lock device axis 130. The lock device 51 has a mounting part 52 that is connected to the receiving element 13. The lock device 51 is configured to apply a force onto the push element 13c so that the upper element 13a of the receiving element 13 is pushed against the lower element 13b of the receiving element 13 so that the receiving element 13 is arranged in the locked position. This way, the part of the endoscope P1 that is arranged in the receiving area 14a, 14b is held in a fixed position and predefined position. In order to arrange the receiving element 13 into the unlocked position, a robot can apply a force F onto the lock device lever 51a so that the lock device lever 51a does not apply a force into the direction of the push element 13c and due to the opening force that is applied by the push element 13c, the upper element 13a of the receiving element 13 is moved at least slightly apart from the lower element 13b of the receiving element 13 so that the receiving element 13 is arranged in the unlocked position. In the unlocked position, the part of the endoscope P1 can be slightly rotated at least with a small angle about its longitudinal axis P1a so that the complete surface of the part of the endoscope P1 can be cleaned.

The first holding device 10 further comprises a lever 19 for moving a control element 58 that is configured and arranged to move an elevator lever of the endoscope between an opened elevator lever position and a closed elevator lever position. Two holding parts 59a, 59b, that are oriented orthogonal to each other, are arranged on the control element 58. With these holding parts 59a, 59b the elevator lever can be moved in both directions parallel to the control element axis 180 by moving the control element 58 along the control element axis 180, such as by moving the lever 19. Due to the structure and the defined positions of these elements and the longitudinally movable control element 58, the control element 58 can be moved along the control element axis 180 by a robot arm in an automated way.

The second holding device 20 is configured to hold a distal tip P2 of the endoscope. The distal tip P2 has a longitudinal axis P2a that extends through the holding device 20. The holding device 20 comprises a frame 21 for placing the holding device 20. The frame 21 is used to place the holding device 20 on a surface, for example on a tray. The holding device 20 further comprises a receiving element 22 and a receiving area 24 in which the part of the endoscope P2 is fixed in the predefined position by the holding elements 26.

The third holding device 30 is configured to hold a light guide plug P3 of the endoscope. The light guide plug P3 has a longitudinal extension that extends through the holding device 30. The holding device 30 comprises a frame 31 with a base plate 30a for placing the holding device 30. The frame 31 is used to place the holding device 30 on a surface, for example on a tray. The holding device 30 further comprises a receiving element 32 and a receiving area 34 in which the part of the endoscope P3 is fixed in the predefined position by the holding elements 36.

The fourth holding device 40 is configured to hold another light guide plug P4 of the endoscope. The light guide plug P4 has a longitudinal extension that extends through the holding device 40. The holding device 40 comprises a frame 41 for placing the holding device 40. The frame 41 is used to place the holding device 40 on a surface, for example on a tray. The holding device 40 further comprises a receiving element 42 and a receiving area 44, in which the part of the endoscope P4 is fixed in the predefined position by the holding elements 46.

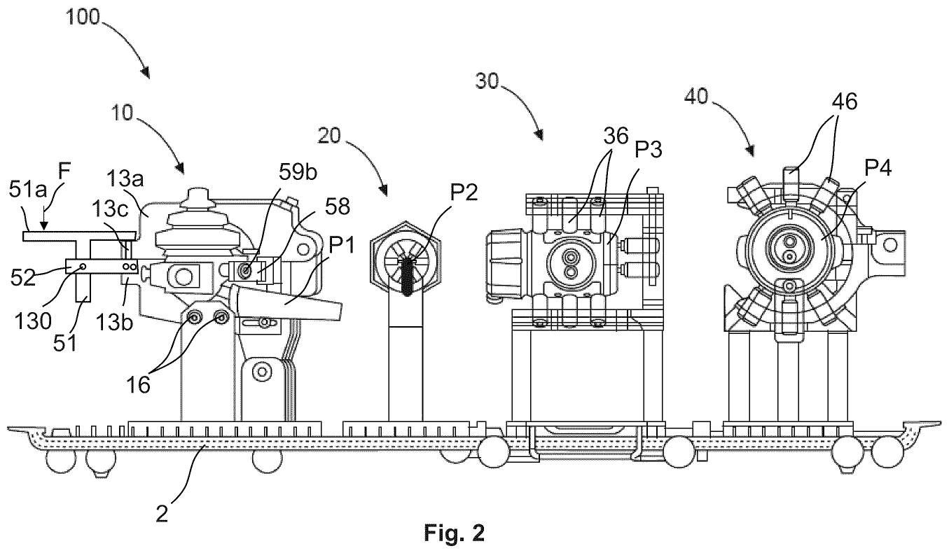

FIG. 2 shows a side view of an arrangement 100 for holding different parts P1, P2, P3, and P4 of an endoscope, comprising four holding devices 10, 20, 30, 40. The holding devices 10, 20, 30, 40 are formed as described above in respect to FIG. 1. For the description of these holding devices 10, 20, 30, 40 it is therefore referred to the explanations above regarding FIG. 1. Here these holding devices 10, 20, 30, 40 are shown in a side view, wherein the holding devices 10, 20, 30, 40 are arranged next to each other on a tray 2.

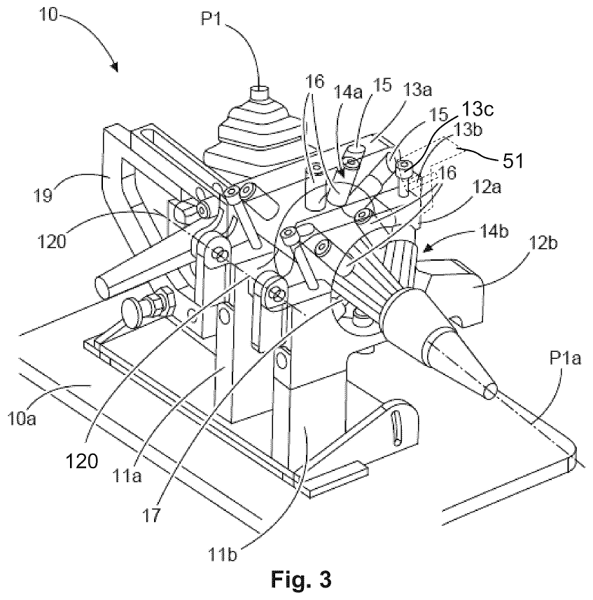

FIG. 3 shows a perspective view of a holding device 10. The holding device 10 is configured to hold an operating part P1 of the endoscope. The operating part P1 has a longitudinal axis P1a that extends through the holding device 10. The holding device 10 is built as described above in respect with the first holding device 10 shown in FIG. 1. Here, in FIG. 3, the holding device 10 is shown in a view from another angle when compared to the view of FIG. 1. Therefore, in FIG. 3 the receiving element 12 can be seen more in detail with the upper element 12a of the receiving element and the lower element 12b of the receiving element. The upper element 12 of the receiving element 12 is rotatable about the substantially horizontal axis 120. The holding elements 16 are screwed into bores 15 that are arranged in the receiving elements 12, 13. For further details of this holding device 10 shown in FIG. 3, it is referred to the explanations pointed out above to with respect to the holding device 10 shown in FIG. 1.

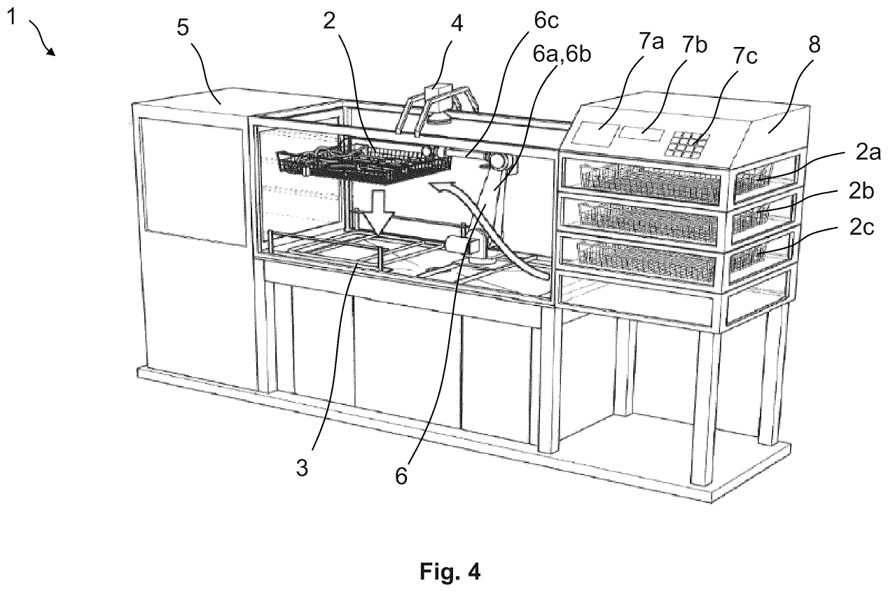

FIG. 4 shows a perspective view of a device for conducting an automated cleaning procedure of the endoscope. This endoscope cleaning device 1 comprises a robot 6 with a robotic arm 6a comprising two robotic arm segments 6b, 6c. A tray area 3 is configured to receive the tray 2. An arrangement for holding different parts of an endoscope as described herein and/or holding devices for holding an endoscope and/or a part of an endoscope as described herein can be placed onto the tray 2. A camera 4 is used to monitor the work space and the endoscope and/or parts of the endoscope arranged in the tray 2. A disinfection device 5 is provided to disinfect the endoscope and/or the parts of the endoscope after having conducted a cleaning procedure. A user interface 7a, 7b, 7c is connected to the control unit 8, so that an operator can indicate the type of the endoscope that is arranged in the trays 2a, 2b, 2c, 2. The camera 4 is connected to a control unit 8 of the endoscope cleaning device 1. The camera 4 is configured to optically identify the type of endoscope arranged in the tray 2, and thus to confirm the type of endoscope indicated by the operator. Furthermore, by using the camera 4, the position of the different parts of the endoscope within the tray 2 can be identified.

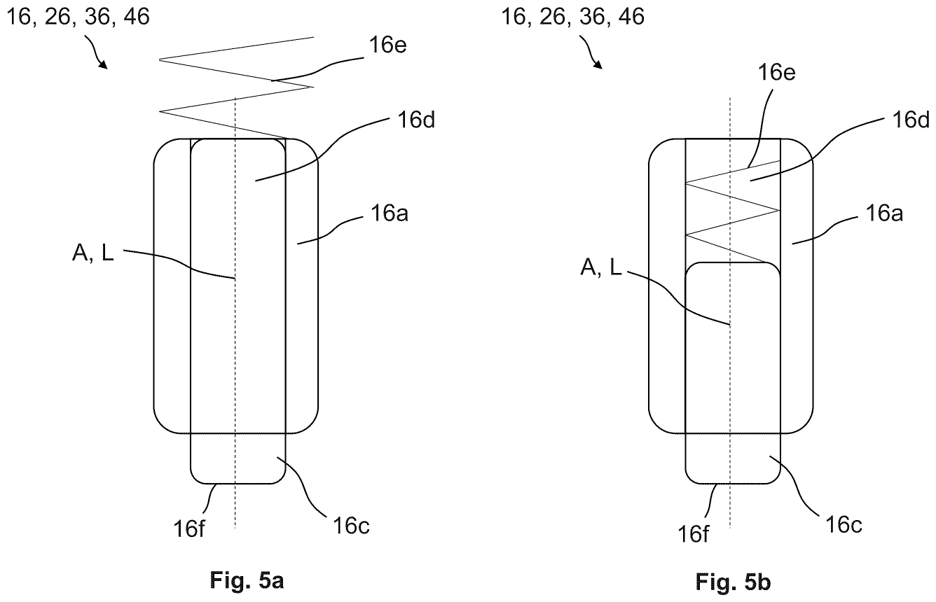

FIG. 5a shows a schematic longitudinal cross-sectional view of a first embodiment of a contact element 16, 26, 36, 46 that can be used as contact element 16, 26, 36, 46 of a holding device 10, 20, 30, 40 as described in respect to FIG. 1 to FIG. 3. The contact element 16, 26, 36, 46 comprises a body 16a and a contact part 16c. The body 16a can be connectable, such as by being screwable, into a bore of a receiving element of a holding device. The contact part 16c is moveable along a moving axis A relative to the body 16a. The moving axis A corresponds to a longitudinal extension L of the holding element 16, 26, 36, 46. The contact part 16c of the holding element 16, 26, 36, 46 has a contact surface 16f for resting against a part of an endoscope that is held in a receiving area of a holding device. The contact surface 16f of the contact part 16c is smaller than the cross section area of the body 16a of the holding element 16, 26, 36, 46 with respect to a cross sectional plane orthogonal to the moving axis A. The contact part 16c of the holding element 16, 26, 36, 46 is biased by a spring element 16e that is formed as a compression spring towards the receiving area in which the endoscope or part of the endoscope that is held in the receiving area of the corresponding holding device is arranged.

FIG. 5b shows a schematic longitudinal cross-sectional view of a second embodiment of a contact element 16, 26, 36, 46 that can be used as contact element 16, 26, 36, 46 of a holding device 10, 20, 30, 40 as described in respect to FIG. 1 to FIG. 3. The contact element 16, 26, 36, 46 shown in FIG. 5b is substantially built like the contact element shown in FIG. 5a. Therefore, regarding the features of the contact element shown in FIG. 5b it is referred to the explanations regarding the contact element shown in FIG. 5a. A difference between the contact elements shown in FIG. 5a and FIG. 5b is that the spring element 16e is arranged outside of the body 16a of the contact element 16, 26, 36, 46 shown in FIG. 5a and inside of the body 16a of the contact element 16, 26, 36, 46 shown in FIG. 5b.

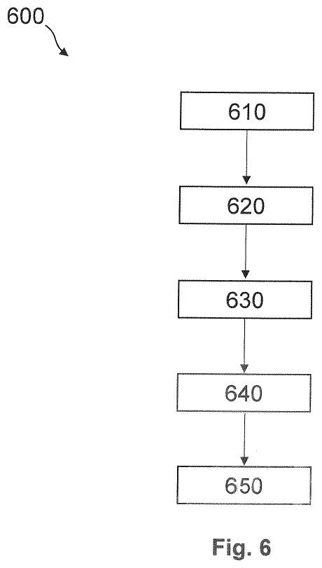

FIG. 6 shows a flow chart of a method 600 for holding an endoscope and/or a part of an endoscope. The method 600 comprises the following steps: In a step 610, providing a holding device for holding an endoscope and/or a part of an endoscope, such as a holding device as described above. In a step 620, placing a part of an endoscope in a receiving area that is at least partly enclosed by a receiving element of the holding device. In a step 630, holding the part of the endoscope in a fixed and predefined position by using a plurality of holding elements that are connected to the at least one receiving element, wherein the holding elements rest against the part of the endoscope and are biased by spring elements towards the part of the endoscope. In a step 640, connecting, such as by using a robot arm of a robot, at least one flushing adapter to at least one channel opening of the part of the endoscope, wherein a liquid can be introduced via the at least one flushing adapter into the at least one channel opening to flush at least one channel of the endoscope. At step 650, in the unlocked position, the part of the endoscope P1 can be slightly rotated at least with a small angle about its longitudinal axis P1a so that the complete surface of the part of the endoscope P1 can be cleaned.

While there has been shown and described what is considered to be embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

### LIST OF REFERENCE SIGNS

1 endoscope cleaning device
2, 2a, 2b, 2c tray
3 tray area
4 camera
5 disinfection device
6 robot
6a robotic arm
6b, 6c robotic arm segments
7a, 7b, 7c user interface
8 control unit
10, 20, 30, 40 holding devices
10a, 30a base plate
11, 21, 31, 41 frame
12, 13, 22, 32, 42 receiving element
12a, 13a upper element of the receiving element
12b, 13b lower element of the receiving element
13c push element
14a, 14b, 24, 34, 44 receiving area
15 bores in receiving element
16, 26, 36, 46 holding elements
16a body of holding element
16c contact part of holding element
16e spring element of holding element
16f contact surface of contact part of holding element
19 lever
51 lock device
51a lock device lever
52 mounting part of lock device
58 control element
59a, 59b holding parts
100 arrangement for holding different parts of an endoscope
120 rotational axis of upper element of the receiving element
130 lock device axis
180 control element axis
600 method
610-640 method steps
A moving axis of holding element
F force applied by robot to lock device lever
L longitudinal extension of holding element
P1, P2, P3, P4 part of an endoscope
P1a, P2a longitudinal axis of part of an endoscope
P1o channel opening of part of an endoscope

What is claimed is:

1. A holding device for holding at least a part of an endoscope, the holding device comprising:
a frame for placing the holding device,
at least one receiving element connected to the frame, the at least one receiving element being configured to at least partly enclose a receiving area for receiving at least the part of the endoscope, and
a plurality of holding elements connected to the at least one receiving element, wherein the plurality of holding elements are each configured to rest against and to hold at least the part of the endoscope in a fixed and predefined position.

2. The holding device according to claim 1, wherein the plurality of holding elements are each movably supported on the at least one receiving element.

3. The holding device according to claim 1, wherein one or more of:
the plurality of holding elements comprises at least six holding elements, and
the at least six holding elements are at least partially formed of a polymer.

4. The holding device according to claim 1, wherein one or more of:
a portion of the plurality of holding elements are arranged along a circumference of the receiving area to hold at least the part of the endoscope, and
a portion of the plurality of holding elements are arranged along a circle.

5. The holding device according to claim 1, wherein the circle is a vertically arranged circle.

6. The holding device according to claim 1, wherein each of the plurality of holding elements comprise a body and a contact part, wherein one or more of the body and the contact part is moveable along a moving axis and relative to the at least one receiving element.

7. The holding device according to claim 6, wherein the moving axis corresponds to a longitudinal extension of the plurality of holding elements.

8. The holding device according to claim 6, wherein one or more of the contact part and the body of each of the plurality of holding elements is biased by a spring element towards the receiving area.

9. The holding device according to claim 8, wherein the spring element is a compression spring.

10. The holding device according to claim 8, wherein the spring element is biased towards at least the part of the endoscope that is held in the receiving area.

11. The holding device according to claim 6, wherein the contact part has a contact surface for resting against at least the part of the endoscope that is held in the receiving area, and the contact surface of the contact part is smaller than a cross sectional area of the body of the holding element.

12. The holding device according to claim 1, wherein the at least one receiving element comprises an upper element movable between an opened position, in which at least the part of the endoscope is placeable into the receiving area and removable from the receiving area, and a closed position, in which at least the part of the endoscope is fixed in the predefined position by the holding elements.

13. The holding device according to claim 1, wherein the upper element is rotatable about a horizontal axis.

14. The holding device according to claim 1, wherein the holding device comprises a lever for moving a control element configured to move an elevator lever of the endoscope between an opened elevator lever position and a closed elevator lever position.

15. The holding device according to claim 14, wherein two holding parts oriented orthogonal to each other are arranged on the control element.

16. The holding device according to claim 12, wherein the holding device comprises a push element arranged to apply an opening force between the upper element of the at least one receiving element and the lower element of the at least one receiving element, wherein the opening force acts such that it is directed to move the upper element of the at least one receiving element and the lower element of the at least one receiving element at least partly apart from each other.

17. The holding device according to claim 1, wherein the holding device comprises a lock device movable between a locked position, in which at least the part of the endoscope held in the receiving area is locked in the predefined and fixed position, and an unlocked position, in which at least the part of the endoscope held in the receiving area is movable about the predefined and fixed position.

18. The holding device according to claim 17, wherein the lock device is rotatable about a lock device axis.

19. The holding device according to claim 1, wherein the at least part of the endoscope comprises one or more of:
an operating part of the endoscope,
a distal tip of the endoscope, and
a light guide plug of the endoscope.

20. An arrangement for holding a plurality of parts of an endoscope, the arrangement comprising:
a plurality of holding devices for holding the plurality of parts, respectively, of the endoscope, wherein at least one of the plurality of holding devices is the holding device according to claim 1.

21. The arrangement according to claim 20, wherein the plurality of holding devices are configured to hold one or more of an operating part of the endoscope, a distal tip of the endoscope; and a light guide plug of the endoscope.

22. A method for holding at least a part of an endoscope, the method comprising:
providing a holding device for holding at least the part of the endoscope;
placing at least the part of the endoscope in a receiving area that is at least partly enclosed by at least one receiving element of the holding device; and
holding at least the part of the endoscope in a fixed and predefined position by using a plurality of holding elements each connected to the at least one receiving element, wherein each of the plurality of holding elements rest against at least the part of the endoscope and each are biased by a spring element towards at least the part of the endoscope.

23. The method according to claim 22, further comprising connecting at least one flushing adapter to at least one channel opening of at least the part of the endoscope.

24. The method according to claim 23, further comprising introducing a liquid via the at least one flushing adapter into the at least one channel opening to flush at least one channel of the endoscope.

25. The method according to claim 23, further comprising using a robot arm to connect the alt least one flushing adapter to the at least one channel.
